(19) United States
(12) Patent Application Publication
(10) Pub. No.: US 2019/0072254 A1
(43) Pub. Date: Mar. 7, 2019

(54) REAR LAMP APPARATUS OF VEHICLE

(71) Applicants: Hyundai Motor Company, Seoul (KR); Kia Motors Corporation, Seoul (KR)

(72) Inventors: Byoung Suk Ahn, Gwacheon (KR); Seung Hyeok Chang, Suwon (KR); Jung Wook Lim, Seoul (KR); Ki Hong Lee, Seoul (KR)

(21) Appl. No.: 15/824,637

(22) Filed: Nov. 28, 2017

(30) Foreign Application Priority Data
Sep. 5, 2017 (KR) 10-2017-0113081

(51) Int. Cl. F21S 43/20; B60Q 1/30; F21S 43/31

(52) U.S. Cl. CPC F21S 43/255; F21S 43/31; B60Q 1/302

(57) ABSTRACT

A rear lamp apparatus of a vehicle is provided. The apparatus includes a light source emits light having a first wavelength band and a light filter that is disposed with a first side facing an exterior and a second side facing an interior of the vehicle, and reflects light having the first wavelength band and transmits light having a second wavelength band that is different from the first wavelength band. The light emitted from the light source is transmitted to the first side of the light filter and is reflected from the light filter to the exterior without being transmitted into the interior. Accordingly, the rear lamp apparatus allows for an enhanced external appearance of a vehicle and provides a new type of rear lamp using rear windshield.

### CROSS REFERENCE TO RELATED APPLICATION

The present application claims priority to Korean Patent Application No. 10-2017-0113081, filed Sep. 5, 2017, the entire contents of which is incorporated herein for all purposes by this reference.

### BACKGROUND

### 1. Field of the Disclosure

The present disclosure relates to a rear lamp apparatus of a vehicle, and more particularly, to a rear lamp apparatus that provides a lighting area on rear windshield and secures a visual field through the lighting area in a non-lighting state.

### 2. Description of the Related Art

Typically, front lamps (e.g., head lamps) for lighting the road ahead of a traveling vehicle during low light conditions are disposed at the front of a vehicle. Additionally, back-up lamps that are turned on when shifting into a reverse gear and brake lamps that are turned on when the brake pedal is engaged are disposed at the rear of a vehicle. Accordingly, an accident such as a rear-end collision may be prevented by enabling the driver in a surrounding vehicle to recognize a change in the operation of a vehicle, for example, when the vehicle is accelerating, decelerating, changing lanes, turning or stopping. Rear lamps include a lens and a housing, and an optical system is disposed in the housing.

As described above, rear lamps are formed from separate components and are attached to a body separately from rear windshield requiring a separate space.

The above description in this section is merely for improving understanding the background of the present disclosure, and should not be should not be taken as an acknowledgement indicating that the information forms a prior art that is already known to a person skilled in the art.

### SUMMARY

The present disclosure provides a rear lamp apparatus of a vehicle configured to turn on a rear lamp on rear windshield and secure a visual field through a lighting area in a non-lighting state.

In accordance with an aspect of an exemplary embodiment of the present disclosure, a rear lamp apparatus of a vehicle may include a light source configured to emit light having a first wavelength band and a light filter disposed with a first side facing an exterior of the vehicle and a second side facing an interior of a vehicle, and configured to reflect light having the first wavelength band and transmit light having a second wavelength band that is different from the first wavelength band. The light emitted from the light source may be transmitted to the first side of the light filter and may be reflected from the light filter to the exterior without being transmitted into the interior.

In some exemplary embodiments, the light source may be disposed at a side of the light filter and may be configured to emit light to the first side of the light filter. The light source may be disposed above or beneath the light filter to enable light from the light source to be transmitted to the light filter from above or beneath the light filter. The apparatus may further include a reflector configured to reflect the light emitted from the light source to the first side of the light filter. The apparatus may further include a light guide disposed at a side of the light filter and configured to guide light emitted from the light source and having a specific incident angle to the exterior.

In other exemplary embodiments, the light guide may be a hologram lens configured to form a specific image by reflecting light emitted from the light source and having a specific incident angle to the exterior. The light guide may be a diffractive lens configured to transmit light emitted from the light source and diffract light reflected from the light filter to the light guide at a specific incident angle after passing through the light guide to transmit the light to the exterior.

In another exemplary embodiment of the present disclosure, a rear lamp apparatus of a vehicle according may include: a light source disposed at a rear position in a vehicle and configured to emit light having a specific first wavelength band and a light filter disposed in the vehicle to correspond to a rear windshield at a rear of the vehicle, with a first side facing the rear windshield of an exterior of the vehicle and a second side facing an interior of the vehicle, and configured to reflect light having the first wavelength band and transmit light having the second wavelength band that is different from the first wavelength band, in which light emitted from the light source is transmitted to the first side of the light filter and is reflected from the light filter to the exterior without being transmitted into the interior.

According to the rear lamp apparatus of a vehicle having the structure described above, a rear lamp may be turned on at a side of the rear windshield and exterior and interior visual fields may be provided through the lighting area in a non-lighting state. Therefore, the design of external appearance of a vehicle may be enhanced and a new type or rear lamp using a rear windshield may be produced.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is an exemplary view illustrating a first embodiment of a rear lamp apparatus of a vehicle and a light guide according to an exemplary embodiment of the present disclosure;

FIG. 2 is an exemplary view illustrating a second embodiment of a rear lamp apparatus of a vehicle and a light guide according to an exemplary embodiment of the present disclosure;

FIG. 3 is an exemplary view showing a rear lamp apparatus of a vehicle according an exemplary embodiment of to the present disclosure; and

FIG. 4 is an exemplary view illustrating the rear lamp apparatus of a vehicle according to an exemplary embodiment of the present disclosure.

### DETAILED DESCRIPTION

While the disclosure will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents and other exemplary embodiments, which may be included within the spirit and scope of the disclosure as defined by the appended claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present disclosure clear, unrelated parts are not shown and, the thicknesses of layers and regions are exaggerated for clarity. Further, when it is stated that a layer is “on” another layer or substrate, the layer may be directly on another layer or substrate or a third layer may be disposed there between.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

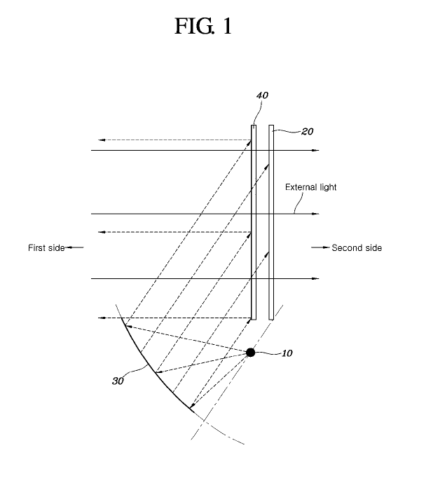

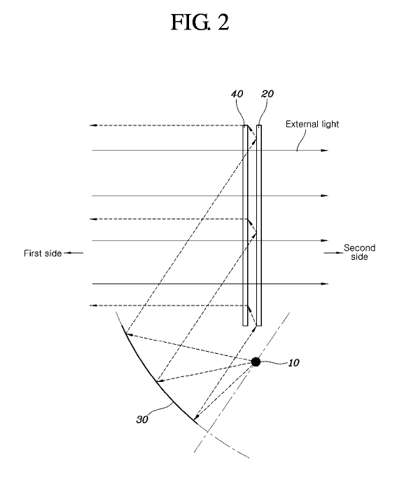

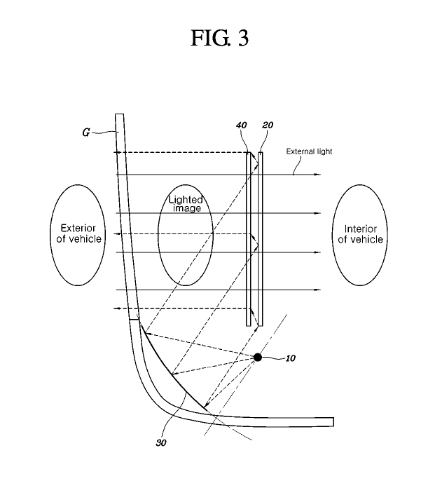

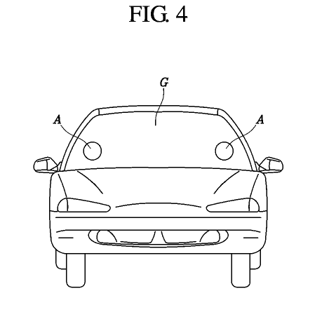

Hereinafter, rear lamp apparatuses of a vehicle according to exemplary embodiments of the present disclosure are described with reference to the accompanying drawings. FIG. 1 is an exemplary view illustrating a first exemplary embodiment of a rear lamp apparatus of a vehicle and a light guide according to the present disclosure. FIG. 2 is an exemplary view illustrating a second exemplary embodiment of a rear lamp apparatus of a vehicle and a light guide according to the present disclosure. FIG. 3 is an exemplary view showing a rear lamp apparatus of a vehicle according to the present disclosure. FIG. 4 is an exemplary view illustrating the rear lamp apparatus of a vehicle according to the present disclosure.

A rear lamp apparatus of a vehicle according to the present disclosure, as shown in FIG. 1, may include a light source 10 that configured to emit light having a first (e.g., specific) wavelength band and a light filter 20 disposed with a first side facing the exterior of the vehicle and a second side facing the interior of a vehicle, and configured to reflect light having a first wavelength band and transmit light having a second wavelength band that is different from the first wavelength band. Light emitted from the light source 10 may be transmitted to the first side of the light filter 20 and may be reflected from the light filter to the exterior without being transmitted into the interior.

As described above, the present disclosure may include of the light source 10 and the light filter 20 and the light emitted from the light source 10 may be reflected from the light filter 20 to the exterior to prevent the light from being transmitted into the interior. The light source may be disposed at a side of the light filter 20 and may be configured to emit light to the first side of the light filter 20, in which the light has the first (e.g., a first specific) wavelength band. In other words, the first side of the light filter 20 may be disposed to face the exterior and the light source 10 may be configured to emit light to the first side of the light filter 20. Accordingly, the light emitted from the light source 10 may be reflected from the first side of the light filter to the exterior. The first wavelength band of the light from the light source 10 may depend on desired colors of light. For example, the light source 10 may be an LED or a laser that emits light having a wavelength band of about 600 to 670 nm to implement a red color.

In particular, the light filter 20 may be a dichroic mirror to reflect light having a first wavelength band and may be configured to transmit light having a second wavelength band that is different from the first wavelength band. When the light filter 20 is a transparent dichroic mirror, as described above, an interior visual field may be provided through the dichroic mirror. Further, light having the first wavelength band may be reflected from the first side of the light filter 20 to the exterior when the light source 10 is turned on. Accordingly, a lighted image produced by the reflected light may be viewed from the exterior of the vehicle. Further, since the light emitted from the light source 10 is not transmitted to the interior by the light filter 20, the light emitted from the light source 10 may be prevented from interfering with the visual fields of the vehicle occupants by being transmitted into the interior. Further, when the light source 10 is turned off, it may be possible to view the exterior through the area A where a lighted image is provided, thereby securing a visual field.

According to the preset disclosure, the light filter 20 may be disposed on rear windshield G and the light source 10 may be disposed to emit light to the first side of the light filter 20. Accordingly, light emitted from the light source 10 disposed in the interior may be reflected from the light filter 20, whereby a lighted image that may be recognized from the exterior through the rear windshield G may be produced. Further, since the light filter 20 reflects light having the first wavelength band when the light source 10 is turned off, light having wavelength bands (e.g., other or second wavelength bands) different from the first wavelength band passes through the light filter 20. In turn, the exterior may be viewed through a lighted image area that is produced when the light source 10 is turned on, thereby securing a visual field.

The present disclosure is described in more detail. The light source 10 may be disposed above or beneath the light filter 20 to transmit light from the light source 10 to the light filter 20 from above or beneath the light filter 20. Further, the apparatus of the present disclosure may further include a reflector 30 configured to reflect the light emitted from the light source 10 to the first side of the light filter 20. When the light source 10 is disposed above the light filter 20, as described above, the light source 10 may be disposed on a roof panel. When the light source 10 is disposed under the light filter 20, the light source 10 may be disposed on a body panel. The light source 10 may be positioned to emit light to the exterior and light emitted from the light source 10 may be reflected from the reflector 30 toward the interior to enable the light to be transmitted to the first side of the light filter 20.

As shown in FIG. 1, light emitted with a first wavelength band from the light source 10 may be turned by the reflector 30 to the first side of the light filter 20. Accordingly, the light traveling to the light filter 20 may be reflected again to the exterior without being transmitted into the interior. The reflector 30 may be a reflector or a mirror having a curvature to reflect light emitted from the light source to the light filter 20. As described above, when the path of the light emitted from the light source 10 is changed by the reflector 30 the layout of the lamp apparatus may be reduced by decreasing the light path. Further, when the light emitted from the light source 10 travels to the light filter 20 a loss of light may be reduced.

Further, as shown in FIG. 1, the apparatus may further include a light guide 40 that is disposed at a side of the light filter 20 and configured to guide light emitted with a from the light source 10 and having a specific incident angle to the exterior. The light guide 40 may include the light filter 20 and may be configured to diffract light emitted from the light source 10 or light reflected from the light filter 20 to the exterior. In particular, the light guide 40 may change the distribution and transmission direction of light having a specific incident angle and may be a hologram optical element (HOE) or a diffractive optical element (DOE).

In particular, the light guide 40 may be a hologram lens configured to produce a specific image by reflecting light emitted from the light source 10 and having a specific incident angle to the exterior. That is, as shown FIG. 1, the light emitted from the light source 10 may be reflected from the reflector 30 toward the light guide 40 and the light guide 40 may include a hologram lens. Accordingly, when the light reaches the light guide 40 a recorded hologram image is produced.

Additionally, according to the principle of recording an image on a hologram lens, when reference light is radiated to an object at a predetermined angle from the opposite side of the object with a hologram lens therebetween, an image by the reference light may be recorded on the hologram lens and object light produced when the reference light is diffusion-reflected from the object may also be recorded on the hologram lens. Further, an interference pattern may be formed on the hologram lens by interference between the reference light and the object light. The interference pattern may be the recorded hologram image implemented by the hologram lens. Accordingly, by adjusting the angle of the light reaching the hologram lens to be the same as the incident angle of the reference light, a hologram image may be formed when light reaches the hologram lens. The angle of the light emitted from the light source 10 reflected from the reflector 30 and being transmitted to the hologram lens may be about the same as the angle of the reference light in recording.

Therefore, as shown in FIG. 1, the light emitted from the light source 10 may be reflected from the reflector 30 toward the light guide 40 and the light guide 40 may be a hologram lens. When the light reaches the light guide 40, a hologram image may be formed by reflecting the incident light. In particular, when the light passes through the light guide 40 and is transmitted to the light filter 20 and the light filter 20 reflects light emitted with the first wavelength band from the light source 10, light may be prevented from being transmitted into the interior.

In another exemplary embodiment, as shown in FIG. 2, the light guide 40 may be a diffractive lens configured to transmit light emitted from the light source 10 and diffract the light reflected from the light filter 20 to the light guide 40 at a specific angle after passing through the light guide 40 to enable the light to be transmitted to the exterior. In other words, as shown in FIG. 2, the light emitted from the light source 10 may be reflected from the reflector 30 toward the light guide 40 and the light guide 40 may include a diffractive lens. When the light reaches the light guide 40 at a specific angle the light guide 40 may be configured to diffract the light to the exterior. In particular, the light emitted from the light source 10 may be transmitted to the light guide 40 and the light filter 20 by the reflector 30. However, the incident angle of the light reaching the light guide 40 may not be the angle required by the diffractive lens that is the light guide 40 and thus the light passes with the incident light through the light guide 40.

As described above, when the light passes through the light guide 40 and is transmitted to the light filter 20, the light filter 20 reflects light emitted with the first wavelength band from the light source 10 and the light may be reflected. Further, the light reflected from the light filter 20 may be transmitted back to the light guide 40 when the incident angle is the specific angle required by the light guide 40. The light may be diffracted to the exterior. Accordingly, light emitted with a specific wavelength band from the light source 10 may be prevented from being transmitted to the interior by the light filter 20 and the light reflected from the light filter 20 may be diffracted to the exterior by the light guide 40 that includes a diffractive lens.

A rear lamp apparatus of a vehicle according to the present disclosure, as shown in FIG. 3, may include a light source 10 disposed at the rear portion in a vehicle and configured to emit light having a first wavelength band and a light filter 20 disposed in the vehicle to correspond to rear windshield G at the rear of the vehicle with a first side facing the rear windshield G of the exterior and a second side facing the interior of the vehicle, and configured to reflect light having the first wavelength band and transmit light having a second wavelength band that is different from the first wavelength band. Light emitted from the light source 10 may be transmitted to the first side of the light filter 20 and may be reflected from the light filter to the exterior without being transmitted into the interior.

As described above, when the light source 10 is disposed at the rear portion in a vehicle and the light filter 20 is disposed at a side of the rear windshield G a lighted image that may be recognized from the exterior through the rear windshield G may be produced after the light emitted from the light source 10 is reflected from the light filter 20. In this process, the light emitted from the light source 10 may be prevented from being transmitted into the interior by the light filter 20. Accordingly, the light emitted from the light source 10 may not be recognized and interference by light may be prevented.

In particular, since the light filter 20 reflects light having the first wavelength band when the light source 10 is turned off, light having a second (e.g., other) wavelength band different from the first wavelength band pass through the light filter 20. Accordingly, the exterior visual field may be secured through a lighted image area A that is produced when the light source 10 is turned on. Therefore, as shown in FIG. 4, when the light source 10 is turned on, a lighted image may be implemented through specific areas A of the rear windshield G When the light source 10 is turned off, the exterior and interior visual fields may be secured through the areas A where the lighted image is implemented.

According to the rear lamp apparatus of a vehicle having the structure described above, a rear lamp may be turned on at a side of the rear windshield G and exterior and interior visual fields may be secured through the lighting area A when the rear lamp is not turned on. Therefore, the external appearance of a vehicle may be more freely designed and a new type of rear lamp using the rear windshield G may be achieved.

Although the present disclosure was described with reference to exemplary embodiments shown in the drawings, it is apparent to those skilled in the art that the present disclosure may be changed and modified in various ways without departing from the scope of the present disclosure, which is described in the following claims.

1. A rear lamp apparatus of a vehicle, comprising:
a light source configured to emit light having a first wavelength band; and
a light filter disposed with a first side facing an exterior of the vehicle and a second side facing an interior of the vehicle, and configured to reflect light having the first wavelength band and transmit light having a second wavelength band different from the first wavelength band, wherein the light emitted from the light source is transmitted to the first side of the light filter and is reflected from the light filter to the exterior of the vehicle without being transmitted into the interior of the vehicle, and
wherein the light filter is a dichroic mirror.

2. The apparatus of claim 1, wherein the light source is disposed at a side of the light filter and configured to emit light to the first side of the light filter.

3. The apparatus of claim 1, further comprising:
a reflector configured to reflect the light emitted from the light source to the first side of the light filter,
wherein the light source is disposed above or beneath the light filter and light from the light source is transmitted to the light filter from above or beneath the light filter.

4. The apparatus of claim 1, further comprising:
a light guide disposed at a side of the light filter and configured to guide light emitted from the light source and having a specific incident angle to the exterior.

5. The apparatus of claim 4, wherein the light guide is a hologram lens configured to produce an image by reflecting light emitted from the light source and having a specific incident angle to the exterior of the vehicle.

6. The apparatus of claim 4, wherein the light guide is a diffractive lens configured to transmit light emitted from the light source and diffract light reflected from the light filter to the light guide at a specific incident angle after passing through the light guide to transmit the light to the exterior of the vehicle.

7. A rear lamp apparatus of a vehicle, comprising:
a light source disposed at a rear portion in a vehicle and configured to emit light having a first wavelength band; and
a light filter disposed in the vehicle to correspond to rear windshield at a rear of the vehicle, with a first side facing the rear windshield of an exterior of the vehicle and a second side facing an interior of the vehicle, and configured to reflect light having the first wavelength band and transmit light having a second wavelength band that is different from the first wavelength band,
wherein light emitted from the light source is transmitted to the first side of the light filter and is reflected from the light filter to the exterior of the vehicle without being transmitted into the interior of the vehicle, and
wherein the light filter is a dichroic mirror.

8. The apparatus of claim 7, further comprising:
a reflector configured to reflect the light emitted from the light source to the first side of the light filter,
wherein the light source is disposed above or beneath the light filter and light from the light source is transmitted to the light filter from above or beneath the light filter.
